(19) United States
(12) Patent Application Publication
(10) Pub. No.: US 2003/0007169 A1
(43) Pub. Date: Jan. 9, 2003

(54) DIGITAL COLOR PRINT SYSTEM USING DIGITAL CAMERA AND DIGITAL COLOR PRINTER

(76) Inventors: CHIHARU TANAKA, TOKYO (JP); YUKIO NAKAJIMA, KANAGAWA-KEN (JP)

Correspondence Address: FRISHAUF HOLTZ GOODMAN, LANGER & CHICK, 25TH FLOOR, 767 THIRD AVENUE, NEW YORK, NY, 100172023

(21) Appl. No.: 09/246,345

(22) Filed: Feb. 8, 1999

(51) Int. Cl. G06F 15/00; B41B 1/00

(52) U.S. Cl. 358/1.15; 358/1.9

(57) ABSTRACT

This invention is a digital color print system having a feature that the printing operation is effected according to the size of printing paper irrespective of the image size of a digital image corresponding to a photographed image and including a digital color printer which can be selectively connected to plural types of digital cameras having different image sizes of images. The digital color print system includes a communication driver for inputting digital image data from the digital camera, an image memory for storing part or all of the input digital image data, a CPU for subjecting the stored digital image data to a preset process so as to convert the stored digital image data to printing data which can be printed and controlling the whole portion of the digital color printer, a switch for specifying printing of the printing data, a print head for effecting the printing operation based on the printing data thus obtained by effecting a preset operation, and a switch for changing the image size corresponding to the input digital image data. The image size can be changed to an image size corresponding to a preset printing size.

### BACKGROUND OF THE INVENTION

This invention relates to a digital color print system having a digital camera for photographing a desired image and storing the image as digital image data and a digital color printer for printing an image based on the digital image data and used for attaining optimum printing based on the image data in a case where the image data is directly output from the digital camera to the digital color printer and printed.

Conventionally, various techniques relating to a digital camera for recording an image by use of a CCD (Charge Coupled Device) instead of a film are proposed.

In this type of digital camera, a photographed image is stored as digital data in a built-in memory such as a flash memory, hard disk or memory card. When an image is photographed by use of the camera, the developing process which is required in the case of a silver film is not necessary and the photographed image can be instantly utilized immediately after the shutter was pressed.

Since an image photographed by use of the camera is stored as digital data in a memory card, hard disk or built-in memory as described before, the photographed image can be printed by use of a digital color printer while monitoring the photographed image on a monitor screen of a personal computer, for example, when it is actually printed. When the image is printed by use of the digital color printer, the darkroom operation which is required in the case of silver photographing can be made unnecessary and a print can be instantly obtained as described before. Further, if the digital data is input to an information processing device such as a personal computer, edition by various image processes such as an enlargement/reduction process can be attained and a print which satisfies the needs of the user can be obtained.

Further, the evaluation for the digital color print system having a combination of the digital camera and the digital color printer becomes higher since an image photographed by use of the digital camera can be instantly recognized and the cost thereof is relatively low. Recently, a system capable of printing an image from the digital camera by use of the digital color printer without using a personal computer is realized and instant printing can be made at a lower cost.

However, when a general person prints an image by use of the digital color printer based on the digital image data obtained by the digital camera, the following problem occurs. That is, when the digital image data obtained by use of the digital camera is printed by using the digital color printer, it is necessary to effect the image processing for the image size of an image on the personal computer or effect the re-size process so as to set the print size corresponding to the size of printing paper. Further, when image data is directly transferred from the digital camera to the digital color printer and the printing operation is effected, it is impossible to set the print size corresponding to the size of printing paper and various problems occur in the actual application.

### BRIEF SUMMARY OF THE INVENTION

This invention has been made to solve the above problems and an object of this invention is to provide a digital color print system having a digital camera and a digital color printer for printing an image with a size corresponding to the size of printing paper by use of the digital color printer irrespective of the image size of a digital image corresponding to an image photographed by use of the digital camera.

In order to attain the above object, according to a first aspect of this invention, there is provided a digital color print system having a digital camera and a digital color printer which can be selectively connected to plural types of digital cameras having different image sizes of images wherein the digital color printer includes communication means for inputting digital image data from the image pickup device by use of preset communication means; storage means for storing part or all of the digital image data input via the communication means; control means for converting the digital image data stored in the storage means to printing data which can be printed by subjecting the digital image data to a preset process and controlling the whole portion of the digital color printer; specifying means for specifying printing of the printing data; printing means for effecting the printing operation by effecting a preset operation based on the printing data obtained by the above operation; operating means for changing an image size corresponding to the input digital image data; and converting means for converting the image size corresponding to the input digital image data to an image size corresponding to a preset printing size by use of the operating means.

According to a second aspect of this invention, there is provided a digital color print system having a digital camera and a digital color printer which can be selectively connected to plural types of digital cameras having different image sizes of images wherein the digital camera includes image pickup means for converting an image pickup signal obtained by photographing an object to digital image data; storage means for storing the digital image data; control means for subjecting the digital image data stored in the storage means to a preset process and controlling the whole portion of the digital camera; selecting means for selecting digital image data associated with an image to be displayed from the digital image data stored in the storage means; display means for displaying an image associated with the digital image data selected by the selecting means after the image is subjected to a preset process by use of the processing means; and communication means for outputting the digital image data stored in the storage means to an external device; and the digital camera has a function of generating an identification signal which can be identified from the communication means.

According to a third aspect of this invention, there is provided a digital color print system having a digital camera and a digital color printer wherein the digital camera includes storage means for storing digital image data corresponding to plural types of image sizes; control means for subjecting the digital image data stored in the storage means to a preset process and controlling the whole portion of the digital camera; selecting means for selecting digital image data associated with an image to be displayed from the digital image data stored in the storage means; display means for displaying an image associated with the digital image data selected by the selecting means after the image is subjected to a preset process by use of the processing means; and first communication means for transmitting the digital image data stored in the storage means and an identification signal for identifying an image size corresponding to the digital image data to the digital color printer; and the digital color printer includes second communication means for receiving the digital image data and the identification signal from the digital camera; storage means for storing part or all of the digital image data input via the second communication means; control means for converting the digital image data stored in the storage means to printing data which can be printed by subjecting the digital image data to a preset process and controlling the whole portion of the digital color printer; specifying means for specifying printing of the printing data; determining means for determining an image size corresponding to digital image data transmitted from the digital camera connected to the second communication means; converting means for converting the image size corresponding to the input digital image data to an image size corresponding to a preset printing size; printing means for printing the printing data obtained by the above operation by effecting a preset operation; and feed means for feeding paper to be printed by the printing means.

According to a fourth aspect of this invention, in an image reproducing system having an image pickup device capable of storing a video signal obtained by photographing an object and reproducing the video signal and a printer capable of receiving the video signal reproduced by the image pickup device and printing the video signal, a digital color print system has a feature that a print start signal is transmitted from the printer side to the image pickup device side after the image size of an image to be printed on the printer side is set.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 is a diagram showing the construction of a digital color print system having a digital camera and a digital printer according to a first embodiment of this invention;

FIG. 2 is a diagram showing the construction of a digital color print system having a digital camera and a digital printer according to a second embodiment of this invention;

FIG. 3 is a view showing the state in which the digital camera and the digital printer are connected to each other via a communication cable to make a print; and

FIG. 4 is a view showing an LCD and various operating switches arranged on the rear surface of the digital camera.

### DETAILED DESCRIPTION OF THE INVENTION

There will now be described embodiments of this invention with reference to the accompanying drawings.

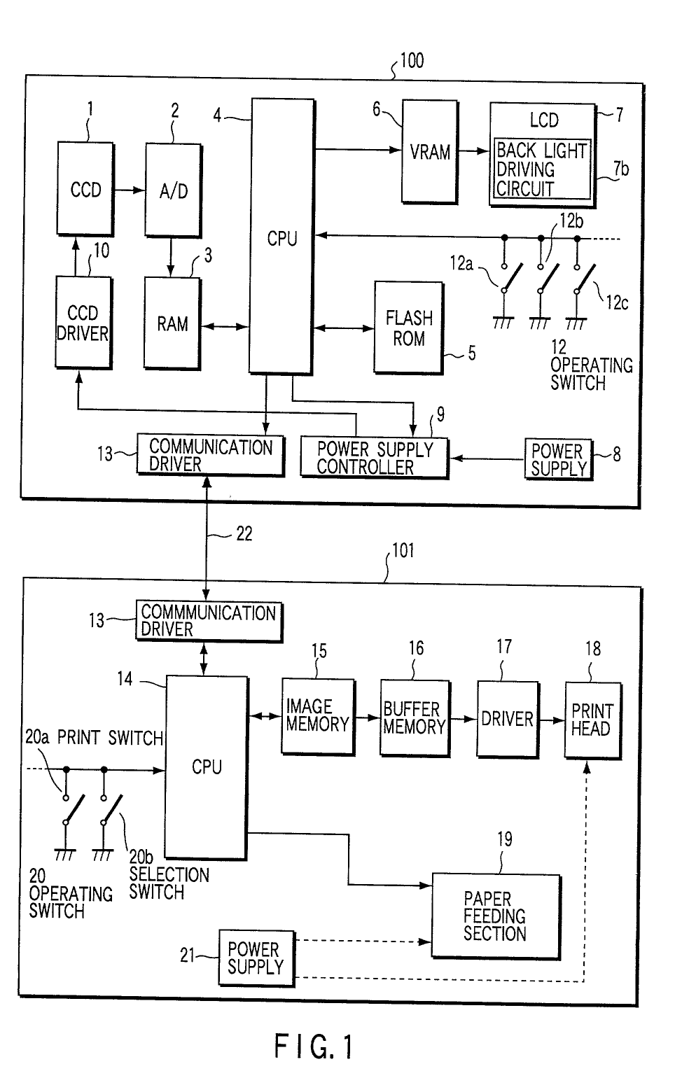

FIG. 1 is a diagram showing the constructions of a digital color print system having a digital camera and a digital printer according to a first embodiment of this invention.

As shown in FIG. 1, on a digital camera 100 side, an output from a CCD 1 for photo-electrically converting light incident via a lens (not shown) to create a video signal is supplied to the input of a central processing unit (CPU) 4 via an analog/digital (A/D) converting circuit 2 and RAM (Random Access Memory) 3. The CCD 1 is driven and controlled by means of a CCD driver 10.

The input of the CPU 4 is further connected to a flash ROM (Read Only Memory) 5, various operating switches 12 and power supply 8. In this example, it is assumed that the flash ROM 5 used as a recording medium is contained in the digital camera, but it is of course possible to use a memory card or magnetic recording medium which can be removably attached, for example.

Further, the operating switches 12 include a reproducing mode switch 12a for specifying display of a liquid crystal display (LCD) 7 and switches 12b, 12c for selecting an image frame to be displayed. As shown in FIG. 4, the switches can be disposed on the rear surface of the digital camera 100 near the position in which the LCD 7 is disposed, for example, but this is not limitative.

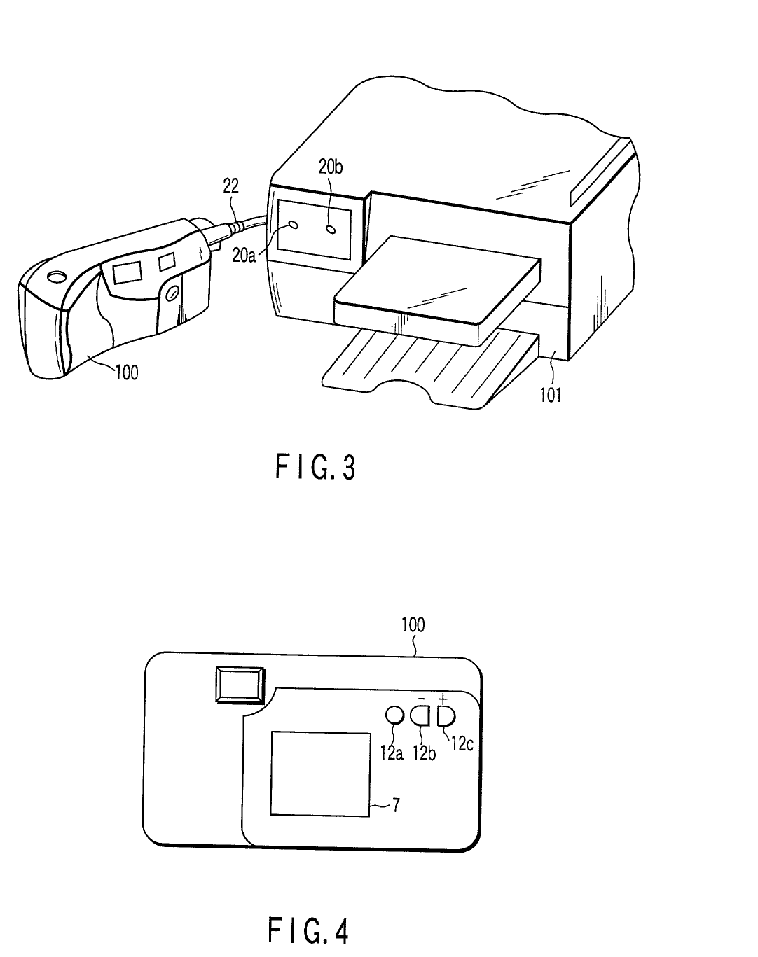

The output of the CPU 4 is connected to the input of the LCD 7 via a VRAM (Video RAM) 6 and connected to the inputs of a power supply controller 9 and communication driver 11. The LCD 7 has a back light driving circuit 7b and is arranged in the preset position of the rear surface of the digital camera 100 as shown in FIG. 4. As shown in FIG. 3, the communication driver 11 makes communication when it is connected to a communication driver 13 on a digital color printer 101 side via a communication cable 22. Further, the power supply controller 9 supplies a voltage of the power supply 8 to the LCD 7, CCD driver 10 and communication driver 11 at a preset timing under the control of the CPU 4. As the power supply 8, an AA battery or chargeable battery may be used, for example.

On the digital color printer 101 side, the communication driver 11 on the digital camera 100 side and the communication driver 13 on the digital color printer 101 side are connected to each other via the communication cable 22 and the output of the communication driver 13 is connected to the input of a CPU 14. The output of the CPU 14 is connected to the input of a paper feeding section 19 and connected to a print head 18 via an image memory 15, buffer memory 16 and driver 17. Further, the CPU 14 is connected to a print start switch (SW) 20a by use of which the operator specifies the print start in a position as shown in FIG. 3, for example, and a selection switch 20b for changing the input image size. A power supply section 21 converts an AC power supply voltage from an external electric supply line to a DC power supply voltage and supplies the voltage at a preset voltage level to various blocks of the digital color printer 101.

The communication drivers 11 and 13 are connected via the communication cable but they can be coupled to each other to attain communication by use of known communication means such as infrared ray or radio communication. Further, as the printing system of the digital color printer 101 with the above construction, for example, a sublimation type heat transfer system can be used. A digital color printer system can be constructed by use of a combination of the digital camera and digital color printer with the above constructions.

With the above construction, in the digital camera 100, an image is photographed by use of the CCD 1 and an analog signal is input to the A/D converting circuit 2. The analog signal is converted into a digital signal by the A/D converting circuit 2 and then temporarily stored in the RAM 3. Data stored in the RAM 3 is read out by the CPU 4 and is subjected to various processes such as JPEG image compression and color conversion, for example, white balance by use of the internal operating section thereof. Then, image data which has been subjected to the above various processes is sequentially stored into the flash ROM 5 for each photographing frame.

If the operator presses the reproducing mode switch 12a in this state, operation information is recognized by the CPU 4 and image data of the flash ROM 5 is read out under the control of the CPU 4, the image data which is compressed to be displayed on the LCD is expanded, data is stored into the image memory VRAM 6 for display and a display image appears on the LCD 7. At this time, a power supply voltage is supplied to the back light driving circuit 7b.

Then, if the operator operates the switches 12b, 12c, image data stored in the flash ROM 5 is adequately selected and sequentially displayed on the LCD 7 as a display image in the same manner as described above. The image size of images recorded on the recording medium is different according to the number of pixels of the CCD 1 of the digital camera 100, different sizes such as VGA and XGA sizes as the image size of an image displayed on the display screen of the personal computer are used and the image sizes corresponding to the respective images are provided. Although not shown in the drawing, in this embodiment, a camera having the image size of an image which is different from that of the digital camera 100 due to the difference in the number of CCD pixels can be connected to the digital color printer 101.

The CPU 14 on the digital color printer 101 side effects the control operation to temporarily store data of one color among one image data, for example, into the image memory 15 when image data from the digital camera 100 is received. At this time, it is of course possible to effect the process such as the color conversion process or contour emphasizing process.

Further, the CPU 14 drives the paper feeding section 19 to feed the paper to be printed and set the paper at the print starting head position and at the same time transfers printing image data stored in the image memory 15 to the buffer memory 16 and controls the print head 18 via the driver 17 to start the printing operation. The print head 18 can simultaneously print data of one line of the printing paper and the paper feeding section 19 feeds the paper by an amount of one line each time the one-line printing is completed.

Thus, the CPU 14 drives the paper feeding section 19 in synchronism with the operation of transferring print data to the print head 18. If the printing operation for a desired image is thus completed, the CPU 14 drives the paper feeding section 19 to discharge the paper. In at least a partial period of a period in which data is transmitted from the digital camera 100 to the digital color printer 101, the operation of the back light driving circuit 7b of the LCD is interrupted for power saving.

If a connection recognition signal is transmitted from the digital color printer 101 to the digital camera 100 when the digital camera 100 and the digital color printer 101 are connected to each other via the communication cable 22, the digital camera 100 can recognize that it is connected to the digital color printer 101 and issues a response signal to the digital color printer 101.

The user displays an image which is desired to be printed on the LCD 7 as a reproducing image by use of the digital camera 100 and specifies start of the printing operation by operating the print start switch 20a in the digital color printer 101. The start of the printing operation may be specified after completion of display of the entire image on the LCD 7. At this time, the image size of an image suitable for the camera connected to the digital color printer is previously selected by means of the selection switch 20b. Selection of the image size of an image may be automatically effected by use of an identification signal from the digital camera 100.

At the time of start of the printing operation, printing data is sequentially transmitted from the digital camera 100 by supplying a print start signal from the digital color printer 101. At this time, the image size of an image suitable for the digital camera 100 connected to the digital color printer is selected by use of the selection switch 20b and, for example, if the selected image size of an image coincides with the size of the printing paper, data is input to the image memory 15 without changing the image size of an image in the process by the digital color printer 101 and if the selected image size of an image is smaller than the size of the printing paper, the re-size process or the enlargement process for enlarging the image size of an image is effected based on the input image data by effecting a preset process to change the image size to a size corresponding to the size of the printing paper.

Thus, if data of one image is output, a print termination signal is issued from the digital color printer 101 and the print operation is terminated. During the printing operation, the operation of the operating switch of the camera is made impossible in the digital camera 100 so as not to change the selected reproducing image and the operation of the operating switch is made possible after the printing operation is terminated.

According to the first embodiment described above, even if any one of plural types of electronic cameras (digital cameras) having different image sizes is connected, the printing operation optimum for the electronic camera (digital camera) connected to the digital color printer can be effected by operating the selection switch of the digital color printer. Particularly, in the digital color printer in which the size of the printing paper is specified, the application thereof becomes more convenient.

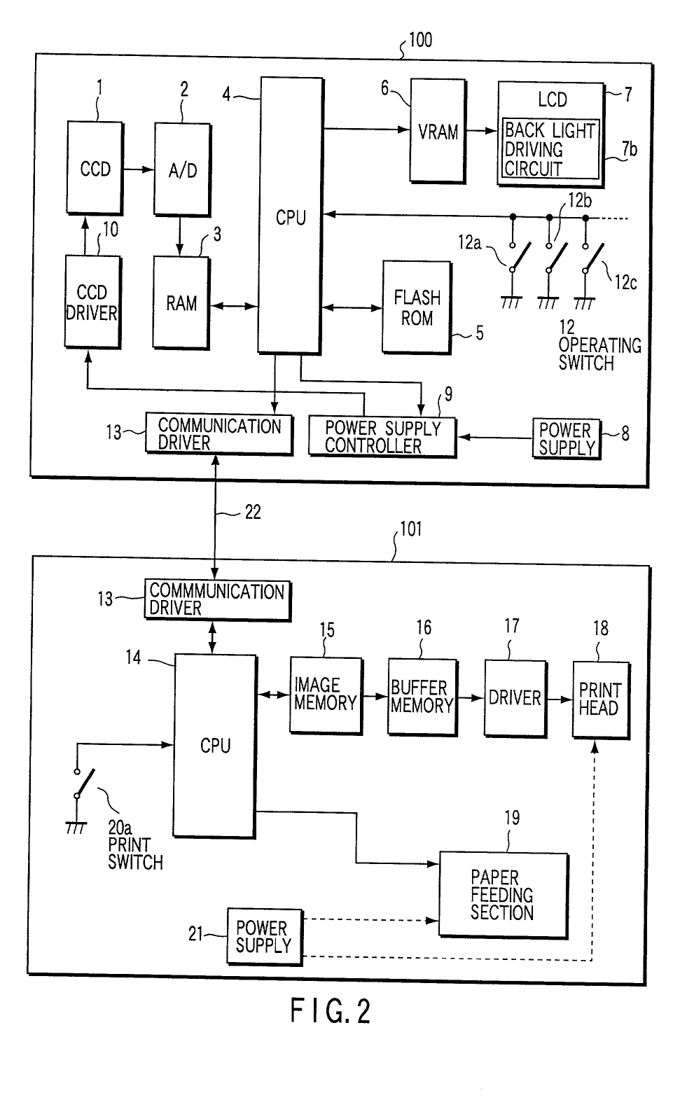

Next, a digital color print system having a digital camera and a digital printer according to a second embodiment of this invention is explained with reference to FIG. 2. A digital camera 100 shown in FIG. 2 has the same construction as that of the first embodiment and therefore the detail explanation thereof is omitted. However, since the storage capacity of a flash ROM 5 of the digital camera 100 is limited when photographed images are recorded on the flash ROM 5, it is considered to freely select a high-quality mode when the high quality is required and select a low-quality mode in a normal case by use of an operating switch 12.

In this case, in the high-quality mode, for example, image data is recorded without changing the image size of an image obtained by the photographing process and, in the low-quality mode, image data is recorded with the image size of an image reduced to, for example, half the image size of an image obtained by the photographing process in the horizontal and vertical directions and the number of images four times the number of images in the case of high quality can be obtained. Changing of the quality modes can be made under the control of the CPU 4.

Also, in the second embodiment, the image size of an image recorded on the recording medium is different according to the number of pixels of the CCD 1 of the digital camera 100 and different sizes such as VGA and XGA sizes as the image size of an image displayed on the display screen of the personal computer are used and the image sizes corresponding to the respective images are provided.

Although not shown in the drawing, in the second embodiment, at least one type of digital camera having a number of CCD pixels different from that of the digital camera 100 described above is provided. Further, on the digital color printer 101 side, a communication driver 11 on the digital camera 100 side and a communication driver 13 are connected to each other via a communication cable 22 and the output of the communication driver 13 is connected to the input of a CPU 14. The output of the CPU 14 is connected to the input of a paper feeding section 19 and connected to a print head 18 via an image memory 15, buffer memory 16 and driver 17.

Further, the CPU 14 is connected to a print start switch (SW) 20a by use of which the operator specifies the print start in a position as shown in FIG. 3, for example. A power supply section 21 converts an AC power supply voltage from an external electric supply line to a DC power supply voltage and supplies the voltage at a preset voltage level to various blocks of the digital color printer 101.

With this construction, if a connection recognition signal is transmitted from the digital color printer 101 to the digital camera 100 when the digital camera 100 and the digital color printer 101 are connected to each other via the communication cable 22, the digital camera 100 can recognize that it is connected to the digital color printer 101 and issues a response signal containing a “type identifying signal” of the digital camera 100 to the digital color printer 101. The identifying signal may contain the number of images to be photographed, the type of the CCD and the image size.

The user displays an image which is desired to be printed on the LCD 7 as a reproducing image by use of the digital camera 100 and starts the printing operation by operating the print start switch 20a in the digital color printer 101. The CPU 14 recognizes that the digital camera which can be used for printing is connected by permitting the digital color printer 101 to obtain the “type identifying signal” of the digital camera 100. Further, like the first embodiment, if the user operates the print start switch 20a of the digital color printer 101 in a state in which an image desired to be printed by the user is displayed on the digital camera 100, the following printing operation is effected after recognizing that the applicable digital camera is connected based on the initial communication at the time of connection.

That is, as the communication for recognition at the print start time, the “operation mode” of the digital camera 100 is recognized to confirm that a reproduction image is displayed on the LCD 7 and it is determined that the image reproduced by the digital camera 100 is the high-quality mode or standard mode as described in the “photographing mode”. The determining process of the CPU 4 is effected based on the “photographing mode” and “type identifying signal” and the printing size optimum for the printing paper can be selected by changing the printing precision according to the image size of an index image or an image input with the printing precision of 240 dpi or 150 dpi or when the print quality mode is set to print an image with the printing precision of 300 dpi, for example. Particularly, it is convenient for a printer which can print an image only with a predetermined paper size.

Further, it is of course possible to set the printing precision other than the above printing precision. In addition, preset communication for preparation for printing is made between the digital color printer 101 and the digital camera 100 but the detail explanation therefor is omitted.

Next, if a print start signal is transmitted from the digital color printer 101 to the digital camera 100, the CPU 4 of the digital camera 100 reads out an image displayed on the LCD 7 from the flash ROM 5 again, develops the image into image data which can be printed by the digital color printer 101 or image data necessary for printing in the RAM 3, and sequentially transmits the image data via the communication cable 22, and the CPU 14 of the digital color printer 101 temporarily stores the image data into the image memory 15 as data to be printed. At the same time, the CPU 14 controls the paper feeding section 19 to feed the paper to the print start position. Then, image data stored in the image memory 15 is supplied to the print head 18 via the buffer memory 16 and driver 17 and printed and the paper feeding section 19 is controlled in synchronism with the operation of the print head to effect the printing operation.

At this time, the image processing is effected according to the precision set by the printing precision in the line direction of the print head 18 to form an image corresponding to the number of dots of the print head 18 and the paper feeding operation suitable for the input image is effected by controlling the paper feeding step in the paper feeding direction. Thus, if data of one image is output, a print termination signal is issued from the digital color printer 101 and the print operation is terminated. During the printing operation, the operation of the operating switch of the camera is made impossible in the digital camera 100 so as not to change the selected reproducing image and the operation of the operating switch is made possible after the printing operation is terminated.

As the communication cable 22 of the above system, it is considered to use a Centronics cable or a serial cable of the specification RS-422 and it becomes possible to commonly use the cable with a connection cable (not shown) connected to a personal computer. In this case, connection to the digital camera 100 is checked at preset intervals as described before, and if it is determined that the digital camera 100 is connected, the digital color printer 101 effects the host operation to maintain the printing state, and if it is determined that the digital camera 100 is not connected, the digital color printer effects the printing operation as a normal printer connected to a personal computer according to the communication protocol from the personal computer and thus the printing operation for both of the camera and the personal computer can be selectively effected.

As described above, according to the second embodiment, since the digital camera 100 can issue a type identifying signal so as to permit the digital color printer 101 to automatically change the printing precision, an optimum printing operation can be attained without imposing an additional load on the user. In the above embodiments, a case wherein the digital camera is used as the image pickup device for the object is explained, but it is not limited to the digital camera and it is possible to use a film scanner for photographing a film image, for example.

The invention described above contains the following inventions.

(1) A digital color printer which can be selectively connected to plural types of image pickup devices having different image sizes of images includes communication means for inputting digital image data from the image pickup device by use of preset communication means; storage means for storing part or all of the digital image data input via the communication means; control means for converting the digital image data stored in the storage means to printing data which can be printed by subjecting the digital image data to a preset process and controlling the whole portion of the digital color printer; specifying means for specifying printing of the printing data; printing means for effecting the printing operation by effecting a preset operation based on the printing data obtained by the above operation; operating means for changing an image size corresponding to the input digital image data; and converting means for converting the image size corresponding to the input digital image data to an image size corresponding to a preset printing size by use of the operating means.

According to the above digital color printer, it is not necessary to change the printing size of the printer in each of the image pickup devices and it is only necessary to make a change on the printer side and thus the cost of the input means can be lowered. Further, since it is not necessary to enlarge the image size and transmit the image even if the printing size of the printer is larger than the size corresponding to the image size of an image from the image pickup device, the communication time can be reduced and as a result the printing time can be reduced.

(2) An electronic image pickup device includes image pickup means for converting an image pickup signal obtained by photographing an object to digital image data; storage means for storing the digital image data; control means for subjecting the digital image data stored in the storage means to a preset process and controlling the whole portion of the electronic image pickup device; selecting means for selecting digital image data associated with an image to be displayed from the digital image data stored in the storage means; display means for displaying an image associated with the digital image data selected by the selecting means after the image is subjected to a preset process by the processing means; and communication means for outputting the digital image data stored in the storage means to an external device; and the electronic image pickup device has a function of generating an identification signal which can be identified from the communication means.

According to the electronic image pickup device, it becomes possible to easily recognize that the image size of an image to be transmitted to the communication destination is a predetermined image size by use of the identification signal. Further, it is possible to easily confirm that the device is a communication connectable type which is previously determined on the communication destination side.

(3) A digital color print system having a digital camera and a digital color printer wherein the digital camera includes storage means for storing digital image data corresponding to plural types of image sizes; control means for subjecting the digital image data stored in the storage means to a preset process and controlling the whole portion of the digital camera; selecting means for selecting digital image data associated with an image to be displayed from the digital image data stored in the storage means; display means for displaying an image associated with the digital image data selected by the selecting means after the image is subjected to a preset process by use of the processing means; and first communication means for transmitting the digital image data stored in the storage means and an identification signal for identifying an image size corresponding to the digital image data to the digital color printer; and the digital color printer includes second communication means for inputting the digital image data and the identification signal from the digital camera; storage means for storing part or all of the digital image data input via the second communication means; control means for converting the digital image data stored in the storage means to printing data which can be printed by subjecting the digital image data to a preset process and controlling the whole portion of the digital color printer; specifying means for specifying printing of the printing data; determining means for determining an image size corresponding to digital image data transmitted from the digital camera connected to the second communication means; converting means for converting the image size corresponding to the input digital image data to an image size corresponding to a preset printing size; printing means for printing the printing data obtained by the above operation by effecting a preset operation; and feed means for feeding paper to be printed by the printing means.

According to the above digital color printer system, in addition to the effect of the digital color printer (1), it is possible to easily and automatically display a printing image suitable for the printing size on the printer side irrespective of the image size from the camera when a print is directly made based on the image from the digital camera.

(4) A digital color printer based on the above digital color printers (1) and (3) has a feature of determining the input of an index image by use of the communication means and converting the size of the image to a preset printing size.

According to the above digital color printer, when the index image is printed, the size of the image is converted to a preset printing size by the image process for processing a file for the index image of the digital camera, and therefore, the image processing time in the digital camera can be made extremely shorter in comparison with that of a normal image file and the printing time in the digital camera and the printer can be greatly reduced.

(5) A digital color printer based on the above digital color printers (1) and (3) has a feature of controlling the operation by identifying the printing based on data from the personal computer and the printing operation based on communication from the digital camera.

According to the above digital color printer, data from the digital camera can be directly printed and at the same time a function of a printer for a personal computer for printing data from the personal computer can be attained by use of one printer.

(6) An electronic image pickup device based on the electronic image pickup device (2) has a feature that the identification signal is an identification signal indicating the image size corresponding to the digital image or the type of the electronic image pickup device.

According to the above electronic image pickup device, image data with a preset printing size can be output by using the identification signal which indicates the image size and a print can be easily and rapidly made by use of a printer which can output only a print with a preset paper size. Further, by using the identification signal which indicates the type, information appendant to the type can be previously set at the time of printing or in the other state (for example, the number of photographing images, CCD type, image size, reproducing mode which can be set).

(7) A digital color printer based on the above digital color printer (1) or (3) has a feature that the printing size is selected according to the printing precision or the image size of an input image.

According to the above digital color printer, since the image size for image data is selected according to the printing precision or the image size of an input image, the re-size process effected between reproduction and printing can be made unnecessary and a hardware necessary for reducing the communication time and converting the size becomes unnecessary, thereby making it possible to lower the cost.

(8) An electronic image pickup device based on the electronic image pickup device (2) has a feature that a selection switch for changing the image size of an input image is attached to the main body of the camera.

According to the above electronic image pickup device, it becomes possible to adequately transmit the image size of an image desired by the user to an output destination device and unnecessary communication time and the re-size process can be omitted.

(9) An electronic image pickup device based on the electronic image pickup device (8) has a feature that the operation of the selection switch is made impossible at least while data is being transmitted to the exterior of the camera.

According to the above electronic image pickup device, occurrence of a problem that the file size of an image transmitted from the middle portion thereof is changed when the setting is changed during the data transmission can be prevented.

(10) An electronic image pickup device based on the electronic image pickup device (2) has a feature that the display means effects the light turn-OFF operation while data is being transmitted to the exterior of the camera.

According to the above electronic image pickup device, the power consumption of the digital camera is reduced to save the power of the battery (charging battery) by turning OFF the liquid crystal display during the data transmission.

(11) In an image reproducing system having an image pickup device capable of storing a video signal obtained by photographing an object and reproducing the video signal and a printer capable of receiving the video signal reproduced by the image pickup device and printing the video signal, a digital color print system has a feature that a print start signal is transmitted from the printer side to the image pickup device side after the image size of an image to be printed on the printer side is set.

According to the digital color print system, since the printing is started after the image size of the image at the time of printing is set, a print of unwanted size can be prevented from being erroneously made.

(12) A digital color print system based on the digital color print system (11) has a feature that the image signal is transmitted to the printer side for printing after display of an image to be printed on the display element contained in the image pickup device is completed.

According to the above digital color print system, since the printing is made possible after the image to be printed is completely recognized, erroneous printing can be prevented.

As described above, according to this invention, a digital color print system having a digital camera and a digital color printer in which images can be directly printed by use of the printer by a simple operation without using an information processing device such as a personal computer by using image data corresponding to image sizes of various images from various digital cameras and the image of a preset printing size can be output.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. A digital color print system comprising:
a digital camera; and
a digital color printer which can be selectively connected to plural types of digital cameras having different image sizes of images;
wherein said digital color printer includes:
communication means for inputting digital image data from the digital camera by use of preset communication means;
storage means for storing part or all of the digital image data input via said communication means;
control means for converting the digital image data stored in said storage means to printing data which can be printed by subjecting the digital image data to a preset process and controlling the whole portion of the digital color printer;
specifying means for specifying printing of the printing data;
printing means for effecting the printing operation by effecting a preset operation based on the printing data obtained by the above operation;
operating means for changing an image size corresponding to the input digital image data; and
converting means for converting the image size corresponding to the input digital image data to an image size corresponding to a preset printing size by use of said operating means.

2. The digital color print system according to claim 1, wherein said digital color printer determines the input of an index image by use of said communication means and converts the size of the image to a preset printing size.

3. The digital color print system according to claim 1, wherein said digital color printer controls the operation by identifying the printing operation by a personal computer and the printing operation by communication from said digital camera.

4. The digital color print system according to claim 1, wherein the printing size is selected according to the printing precision or the image size of an input image in said digital color printer.

5. A digital color print system comprising:
a digital camera; and
a digital color printer which can be selectively connected to plural types of digital cameras having different image sizes of an image;
wherein said digital camera includes:
image pickup means for converting an image pickup signal obtained by photographing an object to digital image data;
storage means for storing the digital image data;
control means for subjecting the digital image data stored in said storage means to a preset process and controlling the whole portion of said digital camera;
selecting means for selecting digital image data associated with an image to be displayed from the digital image data stored in said storage means;
display means for displaying an image associated with the digital image data selected by said selecting means after the image is subjected to a preset process by use of said processing means; and
communication means for outputting the digital image data stored in said storage means to an external device; and
said digital camera has a function of generating an identification signal which can be identified from said communication means.

6. The digital color print system according to claim 5, wherein said digital color printer determines the input of an index image by use of said communication means and converts the size of the image to a preset printing size.

7. The digital color print system according to claim 5, wherein said digital color printer controls the operation by identifying the printing operation by a personal computer and the printing operation by communication from said digital camera.

8. The digital color print system according to claim 5, wherein the identifying signal is an identifying signal indicating the image size for the digital image or the type of said digital camera.

9. The digital color print system according to claim 5, wherein the printing size is selected according to the printing precision or the image size of an input image in said digital color printer.

10. The digital color print system according to claim 5, wherein said digital camera has a selection switch mounted on the main body of the camera, for changing the image size of an input image.

11. The digital color print system according to claim 10, wherein the operation of said selection switch is made impossible at least while data is being transmitted to the exterior of the camera.

12. The digital color print system according to claim 5, wherein said display means effects the light turn-OFF operation in said digital camera while data is being transmitted to the exterior of the main body of the camera.

13. A digital color print system comprising:
a digital camera; and
a digital color printer;
wherein said digital camera includes:
storage means for storing digital image data corresponding to plural types of image sizes;
control means for subjecting the digital image data stored in said storage means to a preset process and controlling the whole portion of said digital camera;
selecting means for selecting digital image data associated with an image to be displayed from the digital image data stored in said storage means;
display means for displaying an image associated with the digital image data selected by said selecting means after the image is subjected to a preset process by use of said processing means; and
first communication means for transmitting the digital image data stored in said storage means and an identification signal for identifying an image size corresponding to the digital image data to said digital color printer; and
said digital color printer includes:
second communication means for receiving the digital image data and the identification signal from said digital camera;
storage means for storing part or all of the digital image data input via said second communication means;
control means for converting the digital image data stored in said storage means to printing data which can be printed by subjecting the digital image data to a preset process and controlling the whole portion of said digital color printer;
specifying means for specifying printing of the printing data;
determining means for determining an image size for digital image data transmitted from said digital camera connected to said second communication means;
converting means for converting the image size corresponding to the input digital image data to an image size corresponding to a preset printing size;
printing means for printing the printing data obtained by the above operation by effecting a preset operation; and
feed means for feeding paper to be printed by said printing means.

14. The digital color print system according to claim 13, wherein said digital color printer determines the input of an index image by use of said second communication means and converts the size of the image to a preset printing size.

15. The digital color print system according to claim 13, wherein said digital color printer controls the operation by identifying the printing operation by a personal computer and the printing operation by communication from said digital camera.

16. The digital color print system according to claim 13, wherein the printing size is selected according to the printing precision or the image size of an input image in said digital color printer.

17. A digital color print system comprising:
an image pickup device capable of storing a video signal obtained by photographing an object and reproducing the video signal; and a printer capable of receiving the video signal reproduced by the image pickup device and printing the image signal; wherein a print start signal is transmitted from the printer side to the image pickup device side after the image size of an image to be printed on the printer side is set.

18. The digital color print system according to claim 17, wherein an image signal is transmitted to the printer side for printing after display of an image to be printed on the display element contained in the image pickup device is completed.
